(19) United States
(12) Patent Application Publication
(10) Pub. No.: US 2026/0199726 A1
(43) Pub. Date: Jul. 16, 2026

(54) BICYCLE TRAINER SYSTEM HAVING HORIZONTALLY ACTING STATOR ASSEMBLY

(71) Applicant: Jetblack Investments Pty Ltd, South Windsor (AU)

(72) Inventor: Tony Simmonds, South Windsor (AU)

(21) Appl. No.: 19/020,229

(22) Filed: Jan. 14, 2025

(30) Foreign Application Priority Data
Jan. 5, 2024 (AU) 2024900029

(51) Int. Cl. A63B 21/005; A63B 22/06; H02K 1/02; H02K 9/06; H02K 11/21; H02K 49/00

(52) U.S. Cl. CPC A63B 21/005; A63B 22/0605; H02K 1/02; H02K 9/06; H02K 11/21; H02K 49/00; A63B 2022/0611; A63B 2220/34; H02K 2213/03

(57) ABSTRACT

The present invention relates, in various embodiments, to an improved bicycle trainer system having a horizontally acting stator assembly. The trainer system has been configured, at least in some embodiments, to operate as a “wheel off” trainer.

### CROSS-REFERENCE TO RELATED APPLICATION

This application claims the benefit of the filing date of Australian Patent Application Serial No. AU2024900029, filed Jan. 5, 2024, for “IMPROVED BICYCLE TRAINER SYSTEM HAVING HORIZONTALLY ACTING STATOR ASSEMBLY,” the disclosure of which is hereby incorporated herein in its entirety by this reference.

### TECHNICAL FIELD

The present disclosure relates, in various embodiments, to an improved bicycle trainer system having a horizontally acting stator assembly. The trainer system has been configured, at least in some embodiments, to operate as a “wheel off” trainer.

### BACKGROUND

Any discussion of the background art throughout the present disclosure should in no way be considered as an admission that such art is widely known or forms part of common general knowledge in the field.

Various common configurations of a bicycle trainer systems include a device that supports the rear of a bicycle. For example, this may include a trainer unit that connects to a rear axle region of the bicycle frame in place of a rear wheel, or a trainer unit into which a conventionally affixed rear wheel of the bicycle is mounted. In either case, a basic premise of the system is that the bicycle is supported in a substantially stable position in which a rider is able to pedal the bicycle in a stationary position with resistance being provided via the trainer unit.

It is known to apply variable resistance in a trainer system by way of electromagnets. For example, various patents relate to the use of a magnetic brake assembly that acts on a flywheel. In such configurations, for example, as taught in U.S. Pat. No. 10,933,290 magnetic force is applied radially outward toward an inner side of a flywheel rim.

Technology disclosed herein seeks to ameliorate problems of the prior art.

### BRIEF SUMMARY

Example embodiments are described below in the section entitled “claims,” and in the section entitled “detailed description.”

An example embodiment provides a bicycle trainer device including:
a frame assembly including:
   (i) a footing assembly having at least three ground engagement members arranged thereby to allow the frame assembly to stably rest on a surface;
   (ii) a bicycle mounting assembly, wherein the bicycle mounting assembly is configured to engage with a pair of opposed rear-wheel dropouts of a bicycle, such that in use the bicycle is stably held in an upright position by the frame assembly;
a drive engagement assembly, wherein upon mounting of the bicycle to the frame assembly via the bicycle mounting assembly, a drivetrain arrangement of the bicycle is functionally coupled to the drive engagement assembly, such that applying pedaling force through the drivetrain arrangement of the bicycle applies a drive force through the drive engagement assembly;
a resistance system that is configured to provide a controllable resistive force that is configured to resist against the pedaling force applied through the drivetrain arrangement of the bicycle;
wherein the resistance system includes:
   (i) a rotor formed of material having predefined magnetic properties, wherein the rotor is configured to rotate about a rotor axis and accelerate in rotation under influence of the drive engagement assembly and decelerate in rotation under influence of controllable resistive force;
   (ii) one or more stator stacks mounted to the frame assembly laterally inward of the rotor, wherein each stator stack includes two or more winding poles that extend laterally from the frame assembly along respective axis that are each substantially parallel with the rotor axis;
   (iii) a stator winding coaxially mounted over each of the winding poles, wherein each stator winding includes a stator wire wound on the stator winding about an axis defined by the respective mounting arm, such that a current applied through the stator windings creates a magnetic resistive force against rotation of the rotor, wherein the level of magnetic resistive force is proportional to attributes of current applied to the windings; and
   (iv) a resistance system controller that is configured to communicate with a simulation system, wherein the communication with the simulation system includes receiving a command representative of a resistance level instruction and in response providing an output that is configured to apply controlled attributes of current applied to the stator windings thereby to deliver the controllable resistive force.
Reference throughout this disclosure to “one embodiment,” “some embodiments” or “an embodiment” means that a particular feature, structure or characteristic described in connection with the embodiment is included in at least one embodiment of the present disclosure. Thus, appearances of the phrases “in one embodiment,” “in some embodiments” or “in an embodiment” in various places throughout this disclosure are not necessarily all referring to the same embodiment but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising,” “comprised of,” or “which comprises” is an open term that means including at least the elements/features that follow, but not excluding others. Thus, the term “comprising,” when used in the claims, should not be interpreted as being limitative to the means or elements or steps listed thereafter. For example, the scope of the expression a device comprising A and B should not be limited to devices consisting only of elements A and B. Any one of the terms “including” or “which includes” or “that includes” as used herein is also an open term that also means including at least the elements/features that follow the term, but not excluding others. Thus, “including” is synonymous with and means “comprising.”

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the present disclosure will now be described, by way of example only, with reference to the accompanying drawings in which:

FIG. 1 illustrates a trainer system and environment according to one embodiment.

FIGS. 2A and 2B illustrate a trainer device according to one embodiment.

FIG. 2C illustrates a trainer device according to another embodiment.

FIG. 3A illustrates a stator stack and windings for the trainer device of FIGS. 2A and 2B.

FIG. 3B illustrates a stator stack and windings for the trainer device of FIG. 2C.

FIG. 4A provides a sectional view of the trainer device of FIGS. 2A and 2B.

FIG. 4B provides a sectional view of the trainer device of FIG. 2C.

FIG. 5A provides a perspective view of a rotor according to an embodiment.

FIGS. 5B and 5C, respectively, provide top and side views of the rotor of FIG. 5A.

### DETAILED DESCRIPTION

The present disclosure relates, in various embodiments, to an improved bicycle trainer system having a horizontally acting stator assembly. This horizontally acting stator assembly is configured to apply a controllable magnetic force to a rotating rotor (rotor), thereby to impart a force that resists rotation of that rotor. This resistance provides pedaling resistance to the trainer system as a whole.

In overview, embodiments relate to bicycle trainer devices having a frame assembly that includes: (i) a footing assembly having at least three ground engagement members arranged thereby to allow the frame assembly to stably rest on a surface; and (ii) a bicycle mounting assembly, wherein the bicycle mounting assembly is configured to engage with a pair of opposed rear-wheel dropouts of a bicycle, such that in use the bicycle is stably held in an upright position by the frame assembly. For example, the bicycle mounting assembly enables mounting of a bicycle (with rear wheel removed) such that the trainer device in essence replaces the rear axle. A drive engagement assembly is provided by the trainer device-upon mounting of the bicycle to the frame assembly via the bicycle mounting assembly, a drivetrain arrangement of the bicycle is functionally coupled to the drive engagement assembly. In this manner, applying pedaling force through the drivetrain arrangement of the bicycle applies a drive force through the drive engagement assembly. A resistance system that is configured to provide a controllable resistive force that is configured to resist against the pedaling force applied through the drivetrain arrangement of the bicycle.

In embodiments described below, the resistance system includes:
(i) A rotor formed of material having predefined magnetic properties. This rotor is configured to rotate about its axis, around which it accelerates in rotation under influence of the drive engagement assembly and decelerates in rotation under influence of controllable resistive force (and general friction forces). The rotor takes the form of a ferrous rotor having a high magnetic permeability and high electrical conductivity. Examples of ferrous metals are iron and steel. Low carbon steels (with a carbon content up to 25%) are preferred for their flux density increasing quickly (high permeability) with increasing magnetic field intensity, saturating in the range of 1.2 T to 2 T. By comparison cast iron increases slower in flux density saturating at about 0.5 T. Low carbon steel also has a high electrical conductivity in the range of 10% IACS to 12% IACS. Of the low carbon steels AISI 1020 (and equivalents such as JIS S20C) are preferred.
(ii) One or more stator stacks (also referred to as stator assemblies) mounted to the frame assembly laterally inward of the rotor. Each stator stack includes two or more winding poles that extend laterally from the frame assembly along respective axis that are each substantially parallel with the rotor axis. Examples described below include trainer devices having multiple stator stacks (for example, with two or more winding poles each), and examples having a single stator stack (preferably with between two and twelve winding poles). Embodiments make use of multiple physically separate but electronically connected stator assemblies. The torque produced by the braking force increases as the stator poles are located further from the axis of rotation (at a larger radius). In a typical radial design, a stator is one circular assembly and so increasing the radius of this assembly increases the cost (one larger piece). By having two (or more) physically separate stator assemblies, these can be positioned with a large radius without increasing the cost. Having pairs of diametrically opposed assemblies providing a balanced axial force on the rotor.
(iii) A stator winding coaxially mounted over each of the winding poles. Each stator winding includes a stator wire wound on the stator winding about an axis defined by the respective mounting arm, such that a current (preferably a direct current DC) applied through the stator windings creates a magnetic resistive force against rotation of the rotor. This level of magnetic resistive force is proportional to attributes of current applied, for example, attributes of a modulated pulse.
(iv) A resistance system controller that is configured to communicate with a simulation system. This communication with the simulation system includes receiving a command representative of a resistance level instruction and in response providing an output that is configured to apply a controlled current having defined attributes to the stator windings thereby to deliver the controllable resistive force (i.e., eddy current influenced braking).

This approach of using stator stacks that mount directly to the frame assembly and deliver magnetic resistance force to a laterally separated rotor member delivers sustainable advantages over known trainer configurations, including in relation to robustness and containment of device costs.

### Example Trainer System

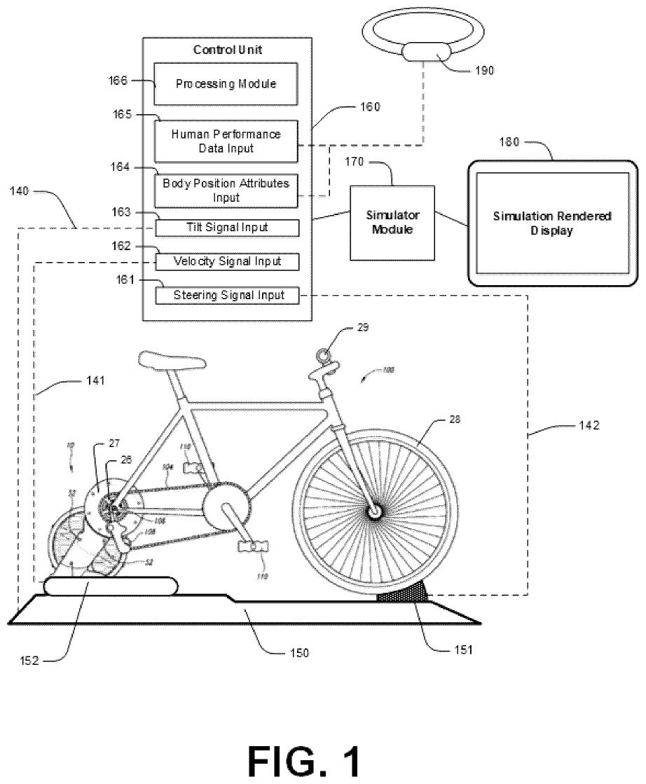

FIG. 1 illustrates an example implementation arrangement according to one embodiment. This example includes an extensive selection of components, not all of which are present in all embodiments. This is provided as general context to trainer devices shown in subsequent drawings.

FIG. 1 illustrates an example arrangement making use of a “wheel-off” trainer assembly 10. Trainer 10 includes an arm 52 that extends from a base member 152. Arm 52 supports a freewheel assembly 27, which is coupled to trainer internals that are configured to provide resistance, monitor rotational velocity, and other functions. Trainer assembly 10 may be operated by a user for stationary riding when coupled to a conventional bicycle 100 (shown in FIG. 1). To use the bike trainer 10, a user first removes the rear wheel of the bicycle 100, secures the rear dropouts 106 of the bicycle to the bike trainer 10, tightens the axle clamp adjustment, and aligns a chain 104 of the bicycle with one of the sprockets of the cassette 26. In operation, the cassette 26 works with a rear derailleur 108 of the bicycle 100 to provide multiple gear ratios for a user of the bike trainer 10. The cassette is mounted to a freewheel assembly 27 of the trainer. In this regard, trainer 10 operates substantially as any of a wide range of known wheel-off trainers. In a further embodiment, arm 52 and assembly 27 are replaced with a wheel-on trainer functional assembly.

Regardless of the style of trainer used, a component of trainer 10 provides an output, which may be wired or wireless (for example, WI-FI® or BLUETOOTH®), which provides what is referred to herein as a “velocity signal,” which represents a simulated velocity based on data observations. The velocity signal is representative of the rate at which bicycle 100 would be moving, if it were not attached to trainer 10 (which is wholly or primarily effected by pedaling of bicycle 100 using pedals 110). This is optionally calculated by measuring a velocity RPM of a component of trainer 10, and extrapolating that to a bicycle wheel size (or, in the case of a wheel-on trainer, based on the linear velocity of the bicycle wheel/tire periphery). The velocity signal is, in some embodiments, additionally representative of other effects of user interaction the drivetrain of bicycle 100 (via pedaling using pedals 110), for instance, optionally including cadence. In some embodiments, the simulated velocity is derived from measurements of power.

The velocity signal is optionally calculated by measuring a velocity RPM of a component of trainer 10, and extrapolating that to a bicycle wheel size (or, in the case of a wheel-on trainer, based on the linear velocity of the bicycle wheel/tire periphery). The velocity signal, is in some embodiments, additionally representative of other effects of user interaction the drivetrain of bicycle 100 (via pedaling using pedals 110), for instance, optionally including cadence.

Velocity signal 141 is transmitted via a wired or wireless coupling to a velocity signal input 162 of a control unit 160. Control unit 160 then passes on the velocity signal, or a signal derived therefrom, to a simulator system 170. In some embodiments, control unit 160 is physically housed inside trainer 10. As described further below, control unit 160 is configured to receive data from a plurality of input sources beyond the velocity signal, in this example including a steering input signal, tilt input signal, motion sensor input signal, and a human performance input signal (e.g., heart rate), and includes a processing module 160. Processing module 160 is configured to provide to simulator module 170 data derived from the various inputs in a predefined format, and is additionally responsive to signals from module 170 to set a resistance parameter for freewheel assembly 27 (for example, to apply the effect of an incline and/or wind resistance relevant to a virtual simulation environment).

Simulator system 170 includes a microprocessor, which is configured to execute computer code (software instructions), which are stored on a memory module of simulator system 170. These software instructions include software instructions configured to provide a bicycle simulator program, which delivers a rendering of a simulation interface on a display screen 180. This simulation preferably includes a representation of vehicular travel (typically bicycle travel), with a velocity of travel being controlled based on the velocity signal. For example, the simulation interface provides a rendered display of simulated bicycle riding at a simulated velocity corresponding to a measured theoretical velocity determined from the velocity signal. It should be appreciated that, although the input device for the simulator in the present disclosure is a bicycle or bicycle-like device, the simulator need not show simulated bicycling (for example, in one embodiment, a user interacts with the bicycle inputs to control an airplane in the virtual environment).

In the illustrated embodiment, a front wheel 28 of bicycle 100 is mounted to a front wheel support unit 151. Front wheel support unit 151 includes a top part that is configured to pivot about a vertical axis, thereby to enable turning of handlebars 29 is bicycle 100, and in doing so simulate steering. A specific example of a suitable wheel support unit is described further below. Support unit 151 includes a sensor, which is configured to measure pivoting, and hence provide a signal representative of bicycle steering activity, referred to as a steering input signal 142. This is transmitted via wired or wireless communication to a steering signal input 161 of control unit 160.

In further embodiments, steering signal 142 is derived by other means. These may include:
A sensor that is configured to directly measure rotation of a steerer tube relative to the frame (particularly relevant in the case of integrated trainers, where there is no front wheel).
An accelerometer mounted to the handlebars or a component that rotates with the handlebars (for example, forks, stem, hub, or the like). In some embodiments, this is provided via a smartphone that is mounted to the handlebars or stem.

As noted, steering signal 142 is transmitted via a wired or wireless coupling to a steering signal input 161 of control unit 160. Control unit 160 then passes on the steering signal, or a signal derived therefrom, to simulator system 170. Simulator system 170 is configured to, based on the steering signal, simulate bicycle steering. For instance, in a simple example, an angle of handlebar 29 steering on bicycle 100 is converted to a degree of simulated bicycle steering/turning in the simulated virtual environment.

In some embodiments, steering simulation via simulator system 170 is controlled via steering signal 142 in isolation. However, in other embodiments, as described below, steering simulation via simulator system 170 is controlled by way of a combination of monitoring steering and bicycle tilt. This combination provides a more realistic simulation, as in practice steering via handlebars is only part of the overall process of steering a bicycle, with tilt being of equal or greater importance.

Tilt is facilitated by way of a tilting plate, also referred to as a rocker plate. Combining tilt and steering into a trainer arrangement provides a much more natural feel to a user, and optionally as discussed herein can allow for an improved simulator system.

An example rocker plate 150 is illustrated. Various forms of rocker plate are commercially available (for example, currently sold by brands KOM Cycling and LifeLine). These rocker plates typically include an upper plate member, to which trainer 10, and optionally wheel support unit 151, is enabled to be mounted. In some embodiments, either or both of trainer 10 and wheel support unit 151 are integrally formed with the upper plate member. The upper plate member is coupled to a lower plate member, such that the upper plate member is able to tilt about a horizontal axis, which is parallel and aligned with the central plane of the bicycle, typically by between 10 and 20 degrees in each direction. This allows a bicycle, when mounted, to tilt from side-to-side. A bias mechanism is provided thereby to provide a bias force between the upper and lower plate mechanisms. In some embodiments, the bias mechanism is provided by one or more pairs of resident balls (for example, inflated rubber balls, tennis-style balls, or the like), which are sandwiched between the upper and lower plates, and disposed evenly to each side of the vertical plane defined by the bicycle. However, other arrangements may also be used.

In some embodiments, a control system is integrated into the rocker plate thereby to provide feedback, which may be used to inhibit tilting in a controlled manner (for example, in response to processing of the velocity signal, thereby to provide feedback representative of centripetal force). This may include a system that selectively increases/decreases pressure in a ball or other bladder, which provides a resilient resistance to tilting of the upper plate relative to the lower plate (a rubberized solution, spring and/or valve may alternately be used to achieve a corresponding result). Such a control system adds significantly to the cost of the overall trainer assembly, but can be used to provide a force feedback mechanism by which simulator logic is able to move the bicycle, adding to a realistic feel. In some embodiments, force feedback, for example, via a servomotor, is integrated into front wheel support unit 151.

Regardless of the style of rocker plate used, a sensor is configured to generate a signal referred to herein as a “tilt signal” 140. The tilt signal 140 is representative of tilt of bicycle 100 relative to a vertical plane. There are various forms of sensor hardware that may be used to generate tilt signal 140, including:
A digital level senor mounted to any of: the upper plate of rocker plate 150; wheel support 151; trainer 10; or a component of bicycle 100.
An IMU, gyroscope, or other such component mounted to any of: the upper plate of rocker plate 150; wheel support 151; trainer 10. For example, this may be an IMU mounted in wheel support 151 configured to determine both steering and tilt, allowing a conventional “dumb” rocker plate to be used.
A smartphone having an IMU mounted to the stem of bicycle 100. This may optionally measure both tilt and steering.
Pressure sensors configured to monitor pressure in bladders (e.g., inflated balls) that are provided by the rocker plate on either side of the bicycle plane, such that pressure changes depending on bicycle tilt (pressure increased in a right-side bladder progressively as the bicycle is tilted further to the right). A load cell or strain gauge may be used.
Strain gauges provided by the rocker plate on either side of the bicycle plane.

Tilt signal 140 is transmitted via a wired or wireless coupling to a velocity signal input 162 of a control unit 160. Control unit 160 then passes on the tilt signal, or a signal derived therefrom, to a simulator system 170.

In some embodiments, control unit 160 processes the steering signal and the tilt signal thereby to provide a single combined steering signal to simulator system 170, this combines signal being in the form of a steering or turning input in a format required by the simulator system (for example, representative of an angle of turn or the like). In other embodiments, this combining of steering and tilt is performed in the simulator system.

Accordingly, simulator system 170 provides a system for providing simulation of bicycle activity, the system including:
(i) A velocity input that is configured to receive a signal representative of user interaction with a bicycle drivetrain mechanism. For example, this is in some cases a signal derived directly or indirectly from a sensor component of trainer 10. This may include a signal that is received by velocity signal input 162, and processed into a form compatible with simulator system 170.
(ii) A steering input that is configured to receive a signal representative of user interaction with a bicycle handlebar turn mechanism. For example, this is in some cases a signal derived directly or indirectly from a sensor component of which provides signal 142, for example, a sensor in unit 151. The steering input may include a signal that is received by steering signal input 161, and processed into a form compatible with simulator system 170.
(iii) A tilting input that is configured to receive a signal representative of user interaction with a bicycle tilt mechanism. For example, this is in some cases a signal derived directly or indirectly from a sensor component of rocker plate 150, or sensor mounted to unit 151 or bicycle 100. This may include a signal 142 that is received by tilt signal input 163, and processed into a form compatible with simulator system 170.

In some embodiments, the steering and tilting input are combined into a single turning metric by control unit 160, and that single turn metric is provided to simulator system 170 to enable control over turning in the simulation. In such cases, system 170 still provides a steering input and a turning input; these are however combined into a single input that receives a signal derived from both steering and turning signals.

In the illustrated embodiment, control unit 160 and simulator system 170 are in combination configured to process the signals received from the velocity input, the steering input and the tilting input, thereby to deliver a visual simulation of bicycle riding via a display screen, wherein the visual simulation includes simulated steering based on a combination of at least:
(i) the signal representative of user interaction with the bicycle handlebar turn mechanism; and
(ii) the signal representative of user interaction with the bicycle tilt mechanism.

The processing is preferably configured such that the simulation is configured to recognize counter steering, as described in PCT publication WO2021/222970.

Control unit 160 provides a data collection and transmission hub for a simulator system such as simulator system 170. Often, hardware associated with simulator system 170 is limited in terms of a number of wireless devices that can be connected (for example, when the simulator system uses, for example, APPLETV® hardware with simulator software executing as a software application thereon). In such cases, control unit 160 is used to receive multiple wireless signals from multiple wireless devices, and provide them as a single wireless signal to the simulator system. This preferably includes one or more wireless signals from bicycle monitoring sensors (for example, velocity, steering angle, tilt, cadence, etc.) and at least one device that collects physiological data from a wearable physiological sensor (for example, a heart rate monitor). The control unit may in this regard be embedded in trainer 10.

The illustrated example includes a torso-mounted heart rate sensor device 190, which includes one or more motion sensor components (e.g., accelerometer, gyroscope, IMU, etc.). Such heart rate sensors are currently available, for example, a device currently marketed under the brand name GARMIN HRM-PRO™. Device 190 provides to control unit 160 a signal representative of human performance data, for example, time series data representative of heart rate. Device 190 additionally provides to control unit 160 a signal representative of body position attributes. This may include raw and/or partially processed motion sensor data (which is, for instance, processed by processing module 166 thereby to determine current body position attributes), or may alternately include processed data that is inherently representative of body position. In relation to the latter, in some examples, device 190 provides data representative of a current state of activity, including data representative of one or more of: standing and pedaling; sitting and pedaling; transitions between standing and pedaling; degree of tuck (angle of torso relative to horizontal); pedaling cadence; torso tilt/lean; and/or other artefacts. It will be appreciated that whether these data artefacts are determined from motion sensor date within device 190, control system 160, or via another processing unit is a matter of design choice.

The body position attribute data is used to control configuration of simulation parameters and/or display parameters as described further above. For example, body position may be used to set simulation parameters relevant to a virtual wind resistance, which may include a parameter that controls simulated deceleration, a parameter that sets trainer resistance; and/or a parameter that affects mapping of a trainer velocity signal to a simulated velocity signal. Body position may also be used to control display parameters, such as body position of an animated virtual avatar in a virtual environment rendered on display 180.

In further embodiments, body position data is received from a component other than device 190, for example, via: (i) a smartphone mounted to the upper body of the user; (ii) another motion sensor enabled device mounted to the upper body of the user; (iii) a smart watch having a motion sensor (in which case standing/seating is inferred from attributes of grip on handlebars); (iv) headwear such as VR/AR equipment, a helmet, or eyewear having in-built motion sensors; (v) processing of data from wheel unit 151 and/or rocker plate 150 (noting that attributes of turning and/or tilting may be processed to determine whether a rider is pedaling in a seated position or a standing position, for example, using an AI classifier trained using data from each scenario); and (vi) other hardware.

In further embodiments, additional sensors may be incorporated. One example is braking sensors (for example, sensors coupled to a brake lever or simulated brake lever), by which a user may provide input that the simulator processes to decrease simulated velocity.

### Example Trainer Device with Horizontally Acting Stator System

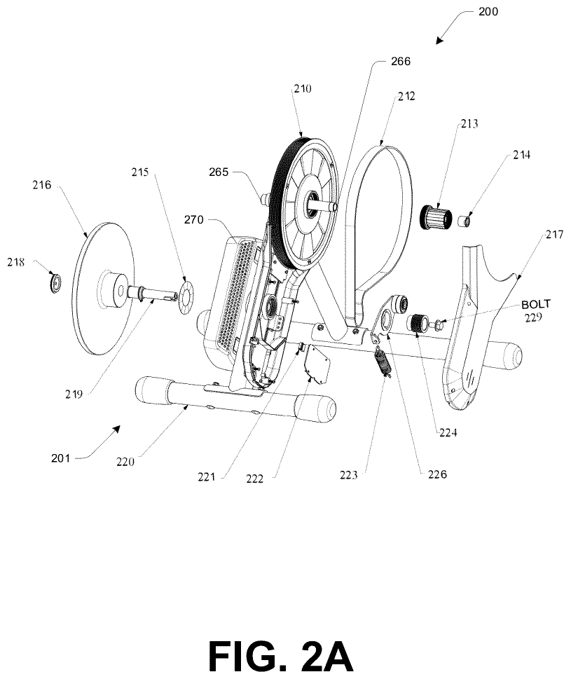

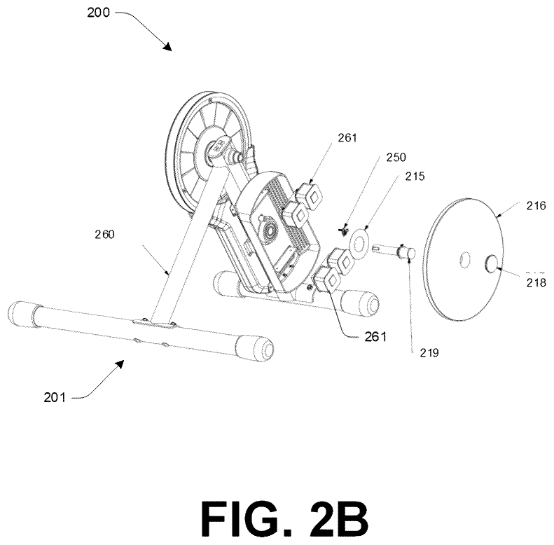

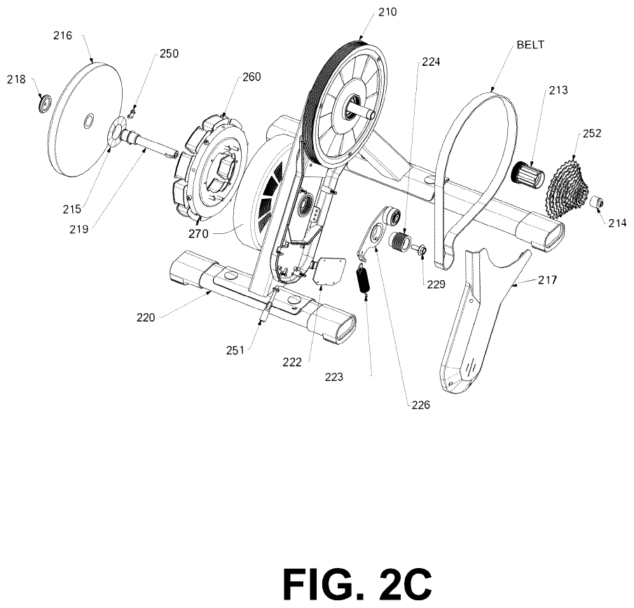

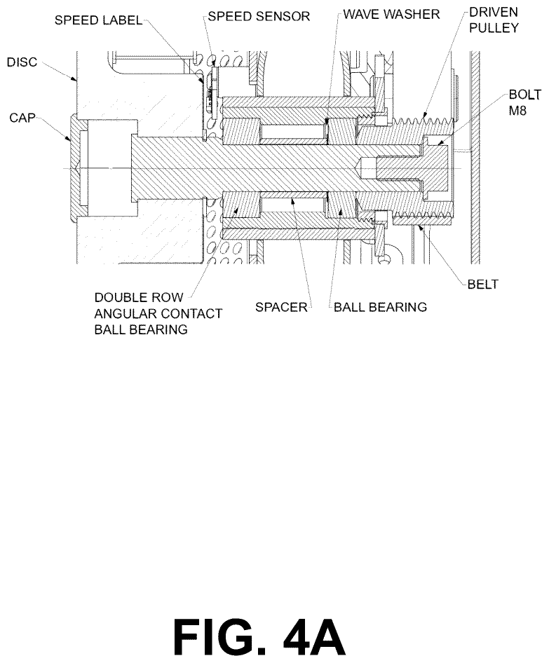

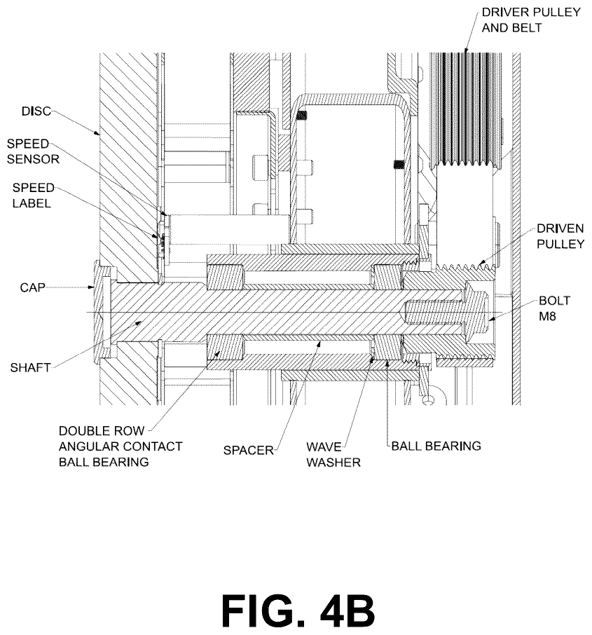

FIG. 2A and FIG. 2B illustrate a first example trainer device 200 with horizontally acting stator system. A second example is shown in FIG. 2C, and corresponding reference numerals are used. FIGS. 4A and 4B provide cross-sectional views of the trainers of FIGS. 2A and 2B and FIG. 2C, respectively.

Trainer 200 includes a frame assembly 201 that is configured to rest stably on a substantially flat surface. In particular, frame assembly 201 includes a footing assembly comprising a pair of elongate supports 220, 221, which are laterally separated. Each support includes footing members at each end, act as ground engagement members arranged thereby to allow the frame assembly to stably rest on a surface. For example, in the illustrated example, these are rubberized sleeves that are mounted on the ends of supports 220, 221. The frame assembly also provides a bicycle mounting assembly 260, which is configured to engage with a pair of opposed rear-wheel dropouts of a bicycle, such that in use, the bicycle is stably held in an upright position by the frame assembly. In this example the dropouts are mounted at locations 265 and 266.

A drive engagement assembly is configured such that, upon mounting of the bicycle to the frame assembly via the bicycle mounting assembly 260, a drivetrain arrangement of the bicycle is functionally coupled to the drive engagement assembly. As a result, applying pedaling force through the drivetrain arrangement of the bicycle applies a drive force through the drive engagement assembly. In the illustrated embodiment, the trainer includes a cassette/driver body 213 (preferably with a freehub mechanism), held on the axle between locations 265 and 266 by a bolt 214. A bicycle cassette 252 is mounted to cassette/driver body 213, thereby to engage with a chain of the mounted bicycle. Pedaling the bicycle causes rotation of a driver pulley 210, which is coupled via a belt 202 to a driver pulley 210 (concealed by a cover 217). The belt is tensioned around these pulleys via a belt tensioner 226 and spring 223. The driven pulley is coupled to a shaft member 219, held in place by a bolt 224, such that there is coupling of rotation between a rotor 216, which is coupled to shaft member 219 (via a cap 218), and the driver pulley 210. That is, acceleration force applied through the drive engagement assembly is applied through both driver pulley 210 and rotor 216, and deceleration (resistive) forces applied to rotor 216 are observed through the drive engagement assembly (i.e., providing resistance to pedaling of the bicycle).

Rotor 216 provides a key component of a resistance system that is configured to provide a controllable resistive force that is configured to resist against the pedaling force applied through the drivetrain arrangement of the bicycle. The rotor is formed of material having predefined magnetic properties. For example, in a preferred embodiment, the rotor takes the form of a ferrous rotor having a high magnetic permeability and high electrical conductivity. Examples of ferrous metals are iron and steel. Low carbon steels (with a carbon content up to 25%) are preferred for their flux density increasing quickly (high permeability) with increasing magnetic field intensity, saturating in the range of 1.2 T to 2 T. By comparison cast iron increases slower in flux density saturating at about 0.5 T. Low carbon steel also has a high electrical conductivity in the range of 10% IACS to 12% IACS. Of the low carbon steels AISI 1020 (and its equivalents such as JIS S20C) are preferred.

The resistance system includes a resistance system controller that is configured to communicate with a simulation system. This communication with the simulation system includes receiving a command representative of a resistance level instruction and in response providing an output that is configured to apply a controlled current having defined attributes to the stator windings thereby to deliver the controllable resistive force. In the illustrated example, a PCB 222 is configured to carry relevant firmware to enable this communication. The firmware also received input data representative of rotational velocity of the rotor via a speed sensor 250, which optionally senses motion of the rotor via a marker 205. A combination of the rotor speed input and a resistance level setting determined based on communication with the simulation system cause the firmware to apply a determined level of current to a stator system.

The stator system is encased in a stator cover 270, and comprises one or more stator stacks mounted to the frame assembly laterally inward of the rotor. Each stator stack includes two or more winding poles that extend laterally from the frame assembly along respective axis that are each substantially parallel with the rotor axis. A stator winding is coaxially mounted over each of the winding poles, wherein each stator winding includes a stator wire wound on the stator winding about an axis defined by the respective mounting arm. In this manner, a current applied through the stator windings creates a magnetic resistive force against rotation of the rotor. The level of magnetic resistive force is proportional to the defined attributes current, and the firmware installed on PCB 222 is configured to control those attributes thereby to deliver a correct level of resistance based on communication from the simulator system and input from the speed sensor.

The current attributes preferably include pulse attributes, which are controlled via pulse modulation (specifically pulse width modulation via control of the voltage across the stator winding). Pulses at a given frequency vary in width (from 0% to 100%) to determine the proportion of each pulse period (known as the duty cycle) that the stator is connected to the DC power source. For the purpose of user experience, the brake resistance can be controlled to be one of a plurality of resistance levels (e.g., between 10 and 50 levels, preferably about 20 levels), or a requested power level, or a simulation of a real-world cycling environment. So, for example, the levels may be defined as 0%, 10%, 20% . . . 100% pulse width.

The system's control software is operated such that there is a distinction between control of resistance from the user's point of view and the actual physical control of the braking force. From a user's point of view, a resistance level is a power curve where power increases with speed with each level having a higher power for a given speed. The trainer software is configured to continuously process measurements via the sped sensor thereby to determined rotational velocity of the rotor, theory to determine if it needs to increase or decrease the brake resistance in order to achieve the desired power at the current speed (via closed loop feedback control). The pulse width modulation is the control of the voltage across the stator winding. Because of the winding inductance the current in the stator will increase when the voltage across it is positive and decrease when it is negative. The current in the winding is controlled by continuously measuring its magnitude and adjusting the pulse width to achieve a desired braking force.

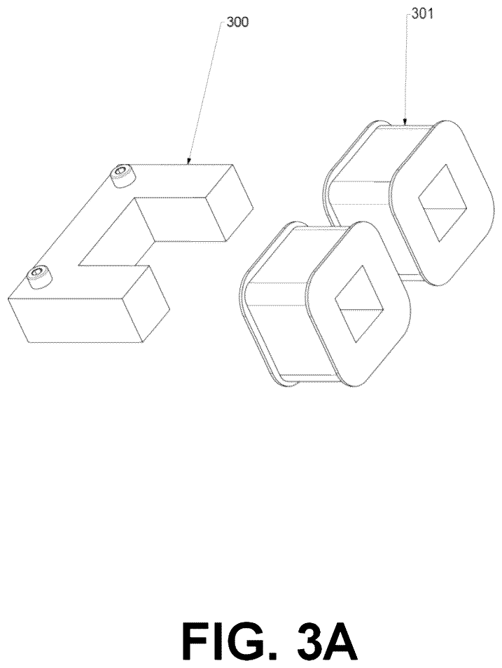

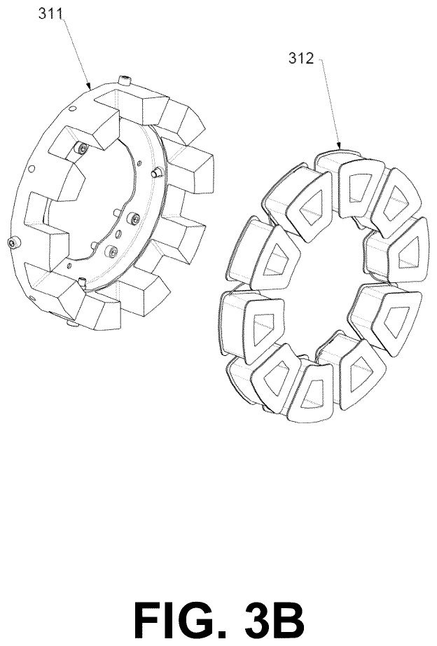

The configuration of the stator stacks provides a key point of distinction between the example of FIGS. 2A and 2B and the example of FIG. 2C. In particular:
In the example of FIGS. 2A, 2B, and 4A, there is a pair of stator stacks having two winding poles each, the pair of stator stacks being diametrically opposed relative to the rotor axis. A more detailed view of a stator stack 300 and winding 301 for this embodiment is shown in FIG. 3A.
In the example of FIGS. 2C and 4B, there is a single stator stack 10 winding poles, with the winding poles being substantially evenly spaced. This is shown in FIG. 3B as a stator stack 311 and windings 312.

In both cases, the stator stacks are mounted directly to the frame, and their winding poles are substantially coaxial with shaft 219, which defines the axle about which rotor 216 rotates.

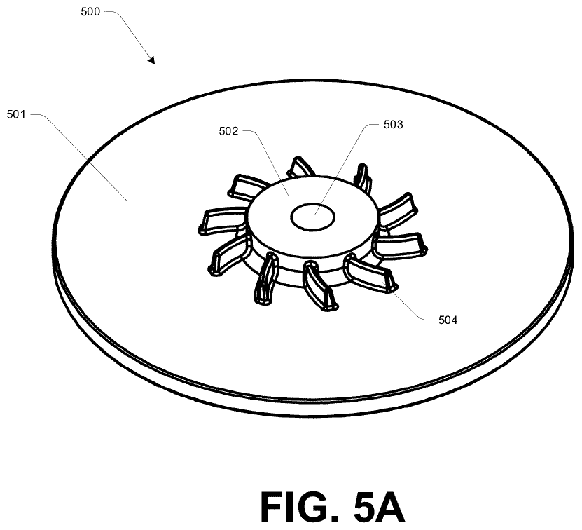

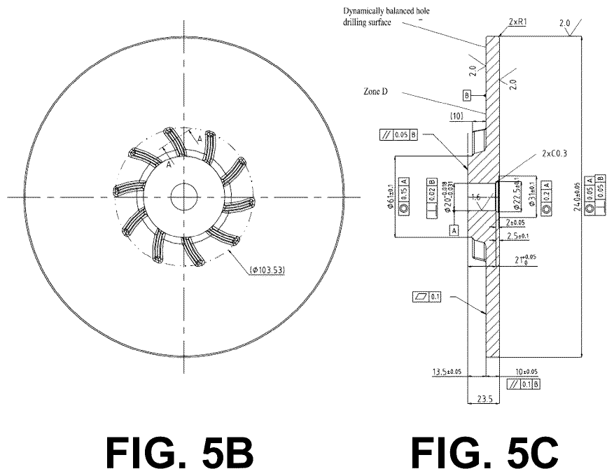

FIG. 5A provides a perspective view of a rotor 500 that is used in various embodiments. For example, rotor 500 may replace rotor 216 in the embodiments of FIG. 2A and FIG. 2B. FIGS. 5B and 5C, respectively, provide top and side views of the rotor of FIG. 5A.

Rotor 500 includes a substantially planar outer radial region 501, which, in use, rotates adjacent the stators, and is influenced by electromagnetic braking forces. An inner region 502 (adjacent central axial aperture 503) really extends beyond the face of region 501 and supports a plurality of air movement encouraging members 504.

As context, in embodiments disclosed herein, braking power is dissipated as heat in the rotor. Compared to certain known arrangements, this axial configuration sits the stators alongside the heat generating rotor (instead of inside it). This separation simplifies the airflow around the stator and rotor. Based on this observation, various embodiments of the present technology make use of air flow encouraging members, for example, in the form of a fan that is integrated with the rotor (e.g., being integrally formed as a single item from homogenous materials). The air flow encouraging members (i.e., fan blades) increase the rotor surface area, and also produce forced airflow across the rotor and stator.

It will be appreciated that the above disclosure provides improved bicycle trainer technology. For example, the use of a rotor in combination with a horizontally acting stator assembly provides for a simpler and more robust alternative to trainer devices that have radially acting stators that act on a surrounding flywheel rim.

It should further be appreciated that in the above description of exemplary embodiments of the present disclosure, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some, but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Thus, while there has been described what are believed to be the preferred embodiments of the present disclosure, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present disclosure.

1. A bicycle trainer device including:
a frame assembly including:
(i) a footing assembly having at least three ground engagement members arranged thereby to allow the frame assembly to stably rest on a surface; and
(ii) a bicycle mounting assembly, wherein the bicycle mounting assembly is configured to engage with a pair of opposed rear-wheel dropouts of a bicycle, such that in use, the bicycle is stably held in an upright position by the frame assembly;
a drive engagement assembly, wherein upon mounting of the bicycle to the frame assembly via the bicycle mounting assembly, a drivetrain arrangement of the bicycle is functionally coupled to the drive engagement assembly, such that applying pedaling force through the drivetrain arrangement of the bicycle applies a drive force through the drive engagement assembly; and
a resistance system that is configured to provide a controllable resistive force that is configured to resist against the pedaling force applied through the drivetrain arrangement of the bicycle,
wherein the resistance system includes:
(i) a rotor formed of material having predefined magnetic properties, wherein the rotor is configured to rotate about a rotor axis and accelerate in rotation under influence of the drive engagement assembly and decelerate in rotation under influence of controllable resistive force;
(ii) one or more stator stacks mounted to the frame assembly laterally inward of the rotor, wherein each stator stack includes two or more winding poles that extend laterally from the frame assembly along respective axis that are each substantially parallel with the rotor axis;
(iii) a stator winding coaxially mounted over each of the winding poles, wherein each stator winding includes a stator wire wound on the stator winding about an axis defined by a respective mounting arm, such that a current applied through the stator windings creates a magnetic resistive force against rotation of the rotor, wherein the level of magnetic resistive force is proportional to attributes of current applied to the windings; and
(iv) a resistance system controller that is configured to communicate with a simulation system, wherein the communication with the simulation system includes receiving a command representative of a resistance level instruction and in response providing an output that is configured to apply controlled attributes of current applied to the stator windings thereby to deliver the controllable resistive force.

2. The device of claim 1, wherein there is a single stator stack having at least four winding poles.

3. The device of claim 2, wherein there is a single stator stack having at least 10 winding poles, wherein the winding poles are substantially evenly spaced.

4. The device of claim 1, wherein there is at least one pair of stator stacks having at least two winding poles each, wherein the pair of stator stacks are diametrically opposed relative to the rotor axis.

5. The device of claim 1, wherein the drive engagement assembly includes a cassette arrangement that rotates about a cassette axis, and a rotor axle that supports the rotor, wherein the cassette arrangement is coupled to the rotor axle via a belt drive arrangement.

6. The device of claim 1, wherein the resistance system controller includes a processor and memory module, wherein the processor is configured to execute software instructions maintained by the memory module thereby to control the attributes of current.

7. The device of claim 1, wherein the resistance system controller includes an input coupled to a speed sensor, wherein the speed sensor provides an input representative of rotational velocity of the rotor.

8. The device of claim 1, wherein the rotor is formed of steel with carbon content of between 5% and 25%.

9. The device of claim 1, wherein the rotor is formed of steel with carbon content of less than 25% and electrical conductivity in the range of 10% IACS to 12% IACS.

10. The device of claim 1, including air flow encouraging members configured to encourage air flow in the region of the stator stacks when the rotor is in motion.

11. The device of claim 10, wherein the air flow encouraging members are provided on the rotor.

12. The device of claim 11, wherein the air flow encouraging members are integrally formed with the rotor.

13. The device of claim 12, wherein the air flow encouraging members define a fan member on the rotor.
